(19) United States
(12) Patent Application Publication
(10) Pub. No.: US 2024/0257022 A1
(43) Pub. Date: Aug. 1, 2024

(54) DIGITAL FINANCIAL MANAGEMENT HAVING CHAT SUPPORT PLATFORM WITH CHAT ROUTING BASED ON COMPOSITE PERFORMANCE RATING OF VIRTUAL TEAM MEMBER

(71) Applicant: Truist Bank, Charlotte, NC (US)

(72) Inventor: Barath Jayaraman, Charlotte, NC (US)

(21) Appl. No.: 18/161,188

(22) Filed: Jan. 30, 2023

(51) Int. Cl. G06Q 10/0639; G06Q 10/0631

(52) U.S. Cl. CPC G06Q 10/06393; G06Q 10/063112

(57) ABSTRACT

A computing device, a computer program product, and a computer-implemented method for delivering enhanced financial services and, more particularly, for facilitating enhanced network communication between a user and a financial institution via a client device. A digital financial management platform for the client device includes a chat support platform that facilitates enhanced chat routing and an enhanced user chat experience. The chat support platform enables a user to have a more efficient chat experience by routing a virtual chat communication session from a virtual support agent to a human virtual support agent based on performance criteria of the human virtual support agent that is indicative of the overall performance attributes of the human virtual support agent.

### TECHNICAL FIELD

The present disclosure relates to a computing device, computer program product, and computer-implemented method for delivering digital financial services and, more particularly, for a chat support platform that facilitates enhanced chat routing and an enhanced user chat experience.

### BACKGROUND

Financial institutions that provide financial services are increasingly providing a greater number of client services. In order to alleviate call and chat density from customers over a network environment, such client services include automated virtual support agents or chatbots who supplement human virtual support agents by directly interacting with customers via text chat, phone, instant messaging, etc.

### SUMMARY

The present disclosure relates to a computing device, a computer program product, and a computer-implemented method for delivering enhanced digital financial services over a communication network by providing a digital financial management platform for a client device that includes a chat support platform that facilitates enhanced chat routing and an enhanced user chat experience. The virtual chat communication session may be routed from an automated virtual support agent to a human virtual support agent (e.g., a human support agent who is either assigned to a branch of the financial institution or a not assigned to branch team of the financial institution) based on performance criteria of the human virtual support agent that is indicative of the overall performance attributes of the human virtual support agent.

For example, the human virtual support agent may be given a performance rating by customers temporally during or temporally after a virtual chat communication session. The performance rating may be associated with a plurality of performance rating levels that correspond to a plurality of numerical performance scores. The performance rating may comprise a global performance rating given by all customers of the financial institution. Alternatively, the performance rating may comprise an individual performance rating given by the user. The individual performance rating may be a single data point derived from a previous chat communication session. The individual performance rating may be an average taken from a plurality of data points derived from a plurality of chat communication sessions.

A virtual chat communication session may be automatically routed from the automated virtual support agent to the human virtual support agent based on a performance rating that is classified as superior. Conversely, routing of the virtual chat communication session from the virtual support agent to the human virtual support agent will be restricted based on a performance rating that is classified as poor.

Alternatively or additionally, the virtual chat communication session may be routed from a virtual support agent to a human virtual support agent based on temporal criteria, such as a virtual chat communication session between the user and the human virtual support agent that occurred within a predetermined threshold time window (e.g., days). For example, the user and the human virtual support agent could have previously conducted a virtual chat communication session within a five-day time window, and on that basis, a current chat communication session will be automatically routed from the virtual support agent to the human virtual support agent.

Alternatively or additionally, the chat support platform enables a user to have a more efficient chat experience by routing a virtual chat communication session from a virtual support agent to a local human virtual support agent located within a predetermined threshold distance from a detected geographic location of the client device.

In accordance with one or more embodiments set forth, illustrated, and described herein, an apparatus may comprise one or more of the following: one or more processors; and a non-transitory memory coupled to the one or more processors, the non-transitory memory including a set of instructions of computer-executable program code, which when executed by the one or more processors, cause the apparatus to: cause, during execution of a mobile application or desktop application associated with a financial institution by a client device of a user over a communication network, a visual display of a chat interface on the client device to facilitate a virtual chat communication session between the user and a virtual support agent of the financial institution; and route the virtual chat communication session from the automated virtual support agent to a human virtual support agent based on a composite performance rating for the human virtual support agent.

In accordance with one or more embodiments set forth, illustrated, and described herein, an apparatus may comprise one or more of the following: one or more processors; and a non-transitory memory coupled to the one or more processors, the non-transitory memory including a set of instructions of computer-executable program code, which when executed by the one or more processors, cause the apparatus to: cause, during execution of a mobile application or desktop application associated with a financial institution by a client device of a user over a communication network, a visual display of a chat interface on the client device to facilitate a virtual chat communication session between the user and a virtual support agent of the financial institution; execute, temporally after acquiring a performance score of a human virtual support agent that is a numerical value indicative of overall performance attributes of the human virtual support agent, human virtual support agent analysis of human virtual support agent data that includes the acquired performance score; and route, based on the human virtual support agent analysis, the virtual chat communication session from the automated virtual support agent to the human virtual support agent of the financial institution.

In accordance with one or more embodiments set forth, illustrated, and described herein, an apparatus may comprise one or more of the following: one or more processors; and a non-transitory memory coupled to the one or more processors, the non-transitory memory including a set of instructions of computer-executable program code, which when executed by the one or more processors, cause the apparatus to: transmit, to a client device of a user executing a mobile application or desktop application associated with a financial institution over a communication network, a first graphical user interface (GUI) for visual display on a user interface of the client device, the first GUI comprising an audio/video feed that facilitates a first virtual chat communication session between the user and a human virtual support agent of the financial institution; transmit, to the client device during the virtual chat communication session, a second GUI for visual display on the user interface, the second GUI comprising a user-engageable link that, when engaged by the user, prompts the user to submit a performance score of the human virtual support agent that is a numerical value indicative of overall performance attributes of the human virtual support agent; execute, temporally after acquiring the performance score, human virtual support agent analysis of human virtual support agent data that is stored in the non-transitory memory; and route, based on the human virtual support agent analysis, a second virtual chat communication session from an automated virtual support agent to the human virtual support agent of the financial institution.

In accordance with each respective apparatus, the set of instructions, which when executed by the one or more processors, cause the apparatus to store the performance score in the non-transitory memory as human virtual support agent data.

In accordance with each respective apparatus, the set of instructions, which when executed by the one or more processors, cause the apparatus to execute, after storing the performance score, a calculation of a composite performance rating for the human virtual support agent.

In accordance with each respective apparatus, the set of instructions, which when executed by the one or more processors, cause the apparatus to acquire, from the user temporally before causing the visual display of the chat interface on the client device to facilitate the virtual chat communication session, a performance score of the human virtual support agent that is a numerical value indicative of overall performance attributes of the human virtual support agent.

In accordance with each respective apparatus, the set of instructions, which when executed by the one or more processors, cause the apparatus to execute, temporally before causing the visual display of the chat interface on the client device to facilitate the virtual chat communication session and temporally after acquiring the performance score, a calculation of the composite performance rating for the human virtual support agent.

In accordance with each respective apparatus, the set of instructions, which when executed by the one or more processors, cause the apparatus to store, temporally before causing the visual display of the chat interface on the client device to facilitate the virtual chat communication session, the composite performance rating in a storage location.

In accordance with each respective apparatus, the composite performance rating is an average of performance scores that are accumulated for the human virtual support agent and stored in the non-transitory memory.

In accordance with each respective apparatus, the composite performance rating is based on performance scores given by all customers of the financial institution.

In accordance with each respective apparatus, the composite performance rating is based on performance scores given by the user.

In accordance with each respective apparatus, the set of instructions, which when executed by the one or more processors, cause the apparatus to route the virtual chat communication session to the human virtual support agent based on a composite performance rating that is indicative of an exemplary performance attributes of the human virtual support agent.

In accordance with each respective apparatus, the set of instructions, which when executed by the one or more processors, cause the apparatus to restrict routing of the virtual chat communication session to the human virtual support agent based on a composite performance rating that is indicative of a poor performance rating of the human virtual support agent.

In accordance with each respective apparatus, the set of instructions, which when executed by the one or more processors, cause the apparatus to detect a current geographic location of the client device based on wireless network connectivity data, stored geographic location data, and sensor data relating to the client device.

In accordance with each respective apparatus, the human virtual support agent data further includes calendar data, scheduling data, educational data, and professional experience data.

In accordance with each respective apparatus, the set of instructions, which when executed by the one or more processors, cause the apparatus to transmit, temporally before detecting the current geographic location of the client device, a request to the client device to authorize the detection of the current geographic location of the client device.

In accordance with each respective apparatus, the set of instructions, which when executed by the one or more processors, cause the apparatus to detect the current geographic location of the client device in response to receiving authorization from the client device.

In accordance with each respective apparatus, the set of instructions, which when executed by the one or more processors, cause the apparatus to cause the display of a GUI comprising a widget on the user interface of the client device, the widget including a professional profile of the local human virtual support agent to whom the chat is being routed.

In accordance with one or more embodiments set forth, illustrated, and described herein, a computer program product comprising at least one non-transitory computer readable medium having with a set of instructions of computer-executable program code, which when executed by one or more processors of a computing device, cause the computing device to execute one or more of the following: cause, during execution of a mobile application or desktop application associated with a financial institution by a client device of a user over a communication network, a visual display of a chat interface on the client device to facilitate a virtual chat communication session between the user and a virtual support agent of the financial institution; and route the virtual chat communication session from the automated virtual support agent to a human virtual support agent based on a composite performance rating of the human virtual support agent.

In accordance with one or more embodiments set forth, illustrated, and described herein, a computer program product comprising at least one non-transitory computer readable medium having with a set of instructions of computer-executable program code, which when executed by one or more processors of a computing device, cause the computing device to execute one or more of the following: cause, during execution of a mobile application or desktop application associated with a financial institution by a client device of a user over a communication network, a visual display of a chat interface on the client device to facilitate a virtual chat communication session between the user and a virtual support agent of the financial institution; execute, temporally after acquiring a performance score of a human virtual support agent that is a numerical value indicative of overall performance attributes of the human virtual support agent, human virtual support agent analysis of human virtual support agent data that includes the acquired performance score; and route, based on the human virtual support agent analysis, a second virtual chat communication session from the automated virtual support agent to the human virtual support agent of the financial institution.

In accordance with one or more embodiments set forth, illustrated, and described herein, a computer program product comprising at least one non-transitory computer readable medium having with a set of instructions of computer-executable program code, which when executed by one or more processors of a computing device, cause the computing device to execute one or more of the following: transmit, to a client device of a user executing a mobile application or desktop application associated with a financial institution over a communication network, a first graphical user interface (GUI) for visual display on a user interface of the client device, the first GUI comprising an audio/video feed that facilitates a first virtual chat communication session between the user and a human virtual support agent of the financial institution; transmit, to the client device during the virtual chat communication session, a second GUI for visual display on the user interface, the second GUI comprising a user-engageable link that, when engaged by the user, prompts the user to submit a performance score of the human virtual support agent that is a numerical value indicative of overall performance attributes of the human virtual support agent; execute, temporally after acquiring the performance score, human virtual support agent analysis of human virtual support agent data that is stored in the non-transitory memory; and route, based on the human virtual support agent analysis, a second virtual chat communication session from an automated virtual support agent to the human virtual support agent of the financial institution.

In accordance with each respective computer program product, the set of instructions, which when executed by the one or more processors, cause the computing device to store the performance score in the non-transitory memory as human virtual support agent data.

In accordance with each respective computer program product, the set of instructions, which when executed by the one or more processors, cause the computing device to execute, after storing the performance score, a calculation of a composite performance rating for the human virtual support agent.

In accordance with each respective computer program product, the composite performance rating is an average of performance scores that are accumulated for the human virtual support agent and stored in the non-transitory memory.

In accordance with each respective computer program product, the set of instructions, which when executed by the one or more processors, cause the computing device to acquire, from the user temporally before causing the visual display of the chat interface on the client device to facilitate the virtual chat communication session, a performance score of the human virtual support agent that is a numerical value indicative of overall performance attributes of the human virtual support agent.

In accordance with each respective computer program product, the set of instructions, which when executed by the one or more processors, cause the computing device to execute, temporally before causing the visual display of the chat interface on the client device to facilitate the virtual chat communication session and temporally after acquiring the performance score, a calculation of the composite performance rating for the human virtual support agent.

In accordance with each respective computer program product, the set of instructions, which when executed by the one or more processors, cause the computing device to store, temporally before causing the visual display of the chat interface on the client device to facilitate the virtual chat communication session, the composite performance rating in a storage location.

In accordance with each respective computer program product, the composite performance rating is based on performance scores given by all customers of the financial institution.

In accordance with each respective computer program product, the composite performance rating is based on performance scores given by the user.

In accordance with each respective computer program product, the set of instructions, which when executed by the one or more processors, cause the computing device to route the virtual chat communication session to the human virtual support agent based on a composite performance rating that is indicative of an exemplary performance attributes of the human virtual support agent.

In accordance with each respective computer program product, the set of instructions, which when executed by the one or more processors, cause the computing device to restrict routing of the virtual chat communication session to the human virtual support agent based on a composite performance rating that is indicative of a poor performance rating of the human virtual support agent.

In accordance with each respective computer program product, the set of instructions, which when executed by the one or more processors, cause the computing device to detect a current geographic location of the client device based on wireless network connectivity data, stored geographic location data, and sensor data relating to the client device.

In accordance with each respective computer program product, the human virtual support agent data further includes calendar data, scheduling data, educational data, and professional experience data.

In accordance with each respective computer program product, the set of instructions, which when executed by the one or more processors, cause the computing device to transmit, temporally before detecting the current geographic location of the client device, a request to the client device to authorize the detection of the current geographic location of the client device.

In accordance with each respective computer program product, the set of instructions, which when executed by the one or more processors, cause the computing device to detect the current geographic location of the client device in response to receiving authorization from the client device.

In accordance with each respective computer program product, the set of instructions, which when executed by the one or more processors, cause the computing device to cause the display of a GUI comprising a widget on the user interface of the client device, the widget including a professional profile of the local human virtual support agent to whom the chat is being routed.

In accordance with one or more embodiments set forth, illustrated, and described herein, a computer-implemented method may comprise one or more of the following: causing, by one or more financial institution servers associated with a financial institution during execution of a mobile application or desktop application associated with the financial institution by a client device of a user over a communication network, a visual display of a chat interface on the client device to facilitate a virtual chat communication session between the user and an automated virtual support agent of the financial institution; and routing, by the one or more financial institution servers, the virtual chat communication session from the automated virtual support agent to a human virtual support agent based on a composite performance rating for the human virtual support agent.

In accordance with one or more embodiments set forth, illustrated, and described herein, a computer-implemented method may comprise one or more of the following: causing, by one or more financial institution servers associated with a financial institution during execution of a mobile application or desktop application associated with the financial institution by a client device of a user over a communication network, a visual display of a chat interface on the client device to facilitate a virtual chat communication session between the user and an automated virtual support agent of the financial institution; executing, by the one or more financial institution servers temporally after acquiring a performance score of a human virtual support agent that is a numerical value indicative of overall performance attributes of the human virtual support agent, human virtual support agent analysis of human virtual support agent data that includes the acquired performance score; and routing, by the one or more financial institution servers based on the human virtual support agent analysis, the virtual chat communication session from the automated virtual support agent to the human virtual support agent of the financial institution.

In accordance with one or more embodiments set forth, illustrated, and described herein, a computer-implemented method may comprise one or more of the following: transmitting, by one or more financial institution servers associated with a financial institution to a client device of a user executing a mobile application or desktop application associated with the financial institution over a communication network, a first graphical user interface (GUI) for visual display on a user interface of the client device, the first GUI comprising an audio/video feed that facilitates a first virtual chat communication session between the user and a human virtual support agent of the financial institution; transmitting, by the one or more financial institution servers to the client device during the virtual chat communication session, a second GUI for visual display on the user interface, the second GUI comprising a user-engageable link that, when engaged by the user, prompts the user to submit a performance score of the human virtual support agent that is a numerical value indicative of overall performance attributes of the human virtual support agent; executing, by the one or more financial institution servers temporally after acquiring the performance score, human virtual support agent analysis of human virtual support agent data that is stored in the non-transitory memory; and routing, by the one or more financial institution servers based on the human virtual support agent analysis, a virtual chat communication session from the automated virtual support agent to the human virtual support agent.

In accordance with each respective computer-implemented method, further comprising storing, by the one or more financial institution servers, the performance score in the non-transitory memory as human virtual support agent data.

In accordance with each respective computer-implemented method, further comprising executing, by the one or more financial institution servers after storing the performance score, a calculation of a composite performance rating for the human virtual support agent.

In accordance with each respective computer-implemented method, the composite performance rating is an average of performance scores that are accumulated for the human virtual support agent and stored in the non-transitory memory.

In accordance with each respective computer-implemented method, further comprising acquiring, from the user by the one or more financial institution servers temporally before causing the visual display of the chat interface on the client device to facilitate the virtual chat communication session, a performance score of the human virtual support agent that is a numerical value indicative of overall performance attributes of the human virtual support agent.

In accordance with each respective computer-implemented method, further comprising executing, by the one or more financial institution servers temporally before causing the visual display of the chat interface on the client device to facilitate the virtual chat communication session and temporally after acquiring the performance score, a calculation of the composite performance rating for the human virtual support agent.

In accordance with each respective computer-implemented method, further comprising storing, by the one or more financial institution servers temporally before causing the visual display of the chat interface on the client device to facilitate the virtual chat communication session, the composite performance rating in a storage location.

In accordance with each respective computer-implemented method, the composite performance rating is based on performance scores given by all customers of the financial institution.

In accordance with each respective computer-implemented method, the composite performance rating is based on performance scores given by the user.

In accordance with each respective computer-implemented method, the second virtual chat communication session is routed to the human virtual support agent of the financial institution based on a composite performance rating that is indicative of an exemplary performance attributes of the human virtual support agent.

In accordance with each respective computer-implemented method, the second virtual chat communication session is not routed to the human virtual support agent based on a composite performance rating that is indicative of a poor performance rating of the human virtual support agent.

In accordance with each respective computer-implemented method, further comprising detecting, by the one or more financial institution servers, a current geographic location of the client device based on wireless network connectivity data, stored geographic location data, and sensor data relating to the client device.

In accordance with each respective computer-implemented method, the human virtual support agent data further includes calendar data, scheduling data, educational data, and professional experience data.

In accordance with each respective computer-implemented method, further comprising transmitting, by the one or more financial institution servers temporally before detecting the current geographic location of the client device, a request to the client device to authorize the detection of the current geographic location of the client device.

In accordance with each respective computer-implemented method, the current geographic location of the client device is detected in response to receiving authorization from the client device.

In accordance with each respective computer-implemented method, further comprising causing, by the one or more financial institution servers, a GUI comprising a widget on the user interface of the client device, the widget including a professional profile of the local human virtual support agent to whom the chat is being routed.

### DRAWINGS

The various advantages of the exemplary embodiments will become apparent to one skilled in the art by reading the following specification and appended claims, and by referencing the following drawings, in which:

FIG. 1 illustrates a communication environment, in accordance with one or more embodiments set forth and described herein.

FIG. 2 illustrates a block diagram of the mobile device of FIG. 1.

FIG. 3 illustrates a block diagram of the personal computing device of FIG. 1.

FIG. 4 illustrates a block diagram of the one or more financial institution servers of FIG. 1.

FIGS. 5 through 7 respectively illustrate a live textual chat communication session between a user and an automated virtual support agent, in accordance with one or more embodiments set forth and described herein.

FIG. 8 illustrates a GUI that displays a professional profile of a local human virtual support agent, in accordance with one or more embodiments set forth and described herein.

FIG. 9 illustrates a GUI comprising an audio/video feed that facilitates a virtual chat communication session between the user and a human virtual support agent of the financial institution, in accordance with one or more embodiments set forth and described herein.

FIG. 9 illustrates a GUI that enable a user to select a performance score that is indicative of the overall performance attributes of a human virtual support agent during a virtual chat communication session, in accordance with one or more embodiments set forth and described herein.

FIGS. 11 through 13 respectively illustrate a computer-implemented method, in accordance with one or more embodiments set forth and described herein.

### DESCRIPTION

Hereinbelow are example definitions that are provided only for illustrative purposes in this disclosure, and should not be construed to limit the scope of the one or more embodiments disclosed herein in any manner. Some terms are defined below for purposes of clarity. These terms are not rigidly restricted to these definitions. This disclosure contemplates that these terms and other terms may also be defined by their use in the context of this description.

As used herein, “application” relates to software used on a computer (usually by a client and/or client device and can be applications that are targeted or supported by specific classes of machine, such as a mobile application, desktop application, tablet application, and/or enterprise application (e.g., client device application(s) on a client device). Applications may be separated into applications which reside on a client device (e.g., VPN, PowerPoint, Excel) and cloud applications which may reside in the cloud (e.g., Gmail, GitHub). Cloud applications may correspond to applications on the client device or may be other types such as social media applications (e.g., Facebook).

As used herein, “artificial intelligence (AI)” relates to one or more computer system operable to perform one or more tasks that normally require human intelligence, such as visual perception, speech recognition, decision-making, and translation between languages.

As used herein, “machine learning” relates to an application of Al that provides computer systems the ability to automatically learn and improve from data and experience without being explicitly programmed.

As used herein, “computer” relates to a single computer or to a system of interacting computers. A computer is a combination of a hardware system, a software operating system and perhaps one or more software application programs. Examples of a computer include without limitation a personal computer (PC), laptop computer, a smart phone, a cell phone, or a wireless tablet.

As used herein, “client device” relates to any device associated with a user, including personal computers, laptops, tablets, and/or mobile smartphones.

As used herein, “modules” relates to either software modules (e.g., code embodied on a machine-readable medium or in a transmission signal) or hardware modules. Certain embodiments are described herein as including logic or a number of components, modules, or mechanisms. A “hardware module” (or just “hardware”) as used herein is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as an FPGA or an ASIC. A hardware module may also include programmable logic or circuitry that is temporarily configured by software to perform certain operations. A hardware module may include software encompassed within a general-purpose processor other programmable processor. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access.

As used herein, “network” or “networks” relates to any combination of electronic communication networks, including without limitation the Internet, a local area network (LAN), a wide area network, a wireless network, and a cellular network (e.g., 4G, 5G).

As used herein, “processes” or “methods” are presented in terms of processes (or methods) or symbolic representations of operations on data stored as bits or binary digital signals within a machine memory (e.g., a computer memory). These processes or symbolic representations are examples of techniques used by those of ordinary skill in the data processing arts to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “processor-Implemented module” relates to a hardware module implemented using one or more processors. The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein.

As used herein, “server” relates to a server computer or group of computers that acts to provide a service for a certain function or access to a network resource. A server may be a physical server, a hosted server in a virtual environment, or software code running on a platform.

As used herein, “service” or “application” relates to an online server (or set of servers), and can refer to a web site and/or web application.

As used herein, “software” relates to a set of instructions and associated documentations that tells a computer what to do or how to perform a task. Software includes all different software programs on a computer, such as applications and the operating system. A software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++, CGI, Java, and Java Scripts. Further, the functions of some embodiments, when described as a series of steps for a method, could be implemented as a series of software instructions for being operated by a processor, such that the embodiments could be implemented as software, hardware, or a combination thereof.

As used herein, “sensor” relates to any device, component and/or system that can perform one or more of detecting, determining, assessing, monitoring, measuring, quantifying, and sensing something.

As used herein, “real-time” relates to a level of processing responsiveness that a user, module, or system senses as sufficiently immediate for a particular process or determination to be made, or that enables the processor to keep up with some external process.

As used herein, “user” relates to a consumer, machine entity, and/or requesting party, and may be human or machine.

In accordance with one or more embodiments set forth, illustrated, and described herein, a chat support platform is provided for a client device of a user having one or more financial accounts residing at one or more financial institution servers of a financial institution. The chat support platform facilitates enhanced chat routing and an enhanced user chat experience. A virtual chat communication session may be routed from an automated virtual support agent to a human virtual support agent based on performance criteria of the human virtual support agent that is indicative of the overall performance attributes of the human virtual support agent.

For example, the human virtual support agent may be given a performance rating by customers temporally during or temporally after a virtual chat communication session. The performance rating may be associated with a plurality of performance rating levels that correspond to a plurality of numerical performance scores. The performance rating may comprise a global performance rating given by all customers of the financial institution. Alternatively, the performance rating may comprise an individual performance rating given by the user. The individual performance rating may be a single data point derived from a previous chat communication session. The individual performance rating may be an average taken from a plurality of data points derived from a plurality of chat communication sessions.

A virtual chat communication session may be automatically routed from the automated virtual support agent to the human virtual support agent based on a performance rating that is classified as superior. Conversely, routing of the virtual chat communication session from the virtual support agent to the human virtual support agent will be restricted based on a performance rating that is classified as poor.

Alternatively or additionally, the virtual chat communication session may be routed from a virtual support agent to a human virtual support agent based on temporal criteria, such as a virtual chat communication session between the user and the human virtual support agent that occurred within a predetermined threshold time window (e.g., days). For example, the user and the human virtual support agent could have previously conducted a virtual chat communication session within a five-day time window, and on that basis, a current chat communication session will be automatically routed from the virtual support agent to the human virtual support agent.

The chat support platform also enables a user to have a more efficient chat experience by routing a virtual chat communication session from a virtual to a local human virtual support agent that is located within a predetermined threshold distance from a detected geographic location of the client device.

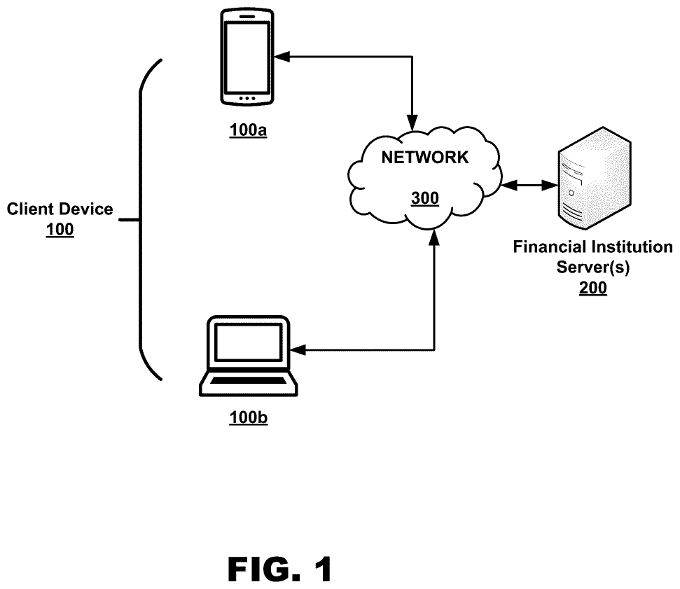

Turning to the figures, in which FIG. 1 illustrates a communication environment that facilitates communications between a user and a financial institution. A client device 100 of a user (financial account holder) operating in the communication environment facilitates user access to and user management of one or more financial accounts residing at one or more financial institution servers 200 of the financial institution. The communication environment includes the client device 100, the one or more financial institution servers 200, and a communication network 300 through which communication is facilitated between the client device 100 and the one or more financial institution servers 200.

In accordance with one or more embodiments set forth, described, and/or illustrated herein, the client device 100 comprises a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the client device 100 comprising any form of electronic device that optimizes or otherwise transforms the performance and functionality of the one or more embodiments in a manner that falls within the spirit and scope of the principles of this disclosure.

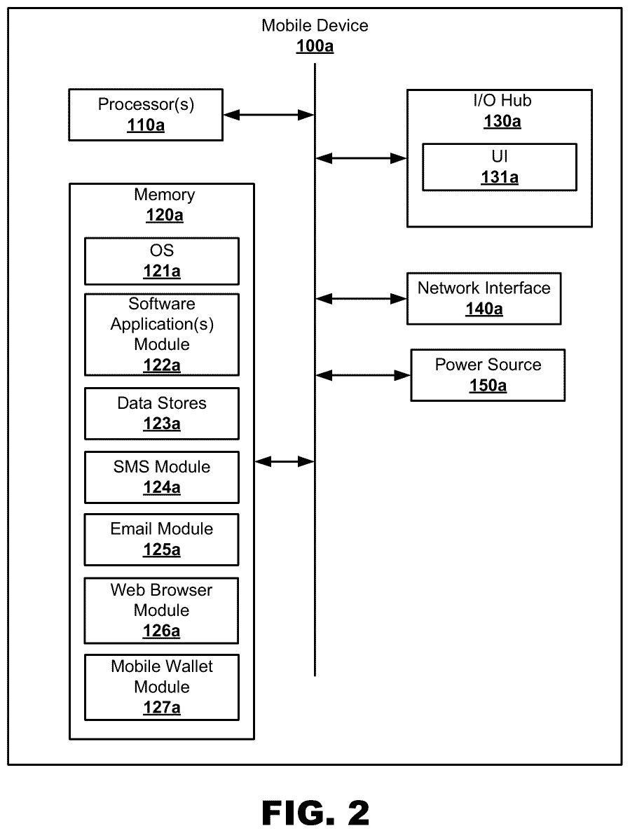

In the illustrated example embodiment of FIG. 2, the client device 100 comprises a mobile device 100a. Some of the possible operational elements of the mobile device 100a are illustrated in FIG. 2 and will now be described herein. It will be understood that it is not necessary for the mobile device 100a to have all the elements illustrated in FIG. 2. For example, the mobile device 100a may have any combination of the various elements illustrated in FIG. 2. Moreover, the mobile device 100a may have additional elements to those illustrated in FIG. 2.

The mobile device 100a includes one or more processors 110a, a non-transitory memory 120a operatively coupled to the one or more processors 110a, an I/O hub 130a, a network interface 140a, and a power source 150a.

The memory 120a comprises a set of instructions of computer-executable program code. The set of instructions are executable by the one or more processors 110a to cause execution of an operating system 121a and one or more software applications of a software application module 122a that reside in the memory 120a. The one or more software applications residing in the memory 120a includes, but is not limited to, a mobile application that is associated with the financial institution. The mobile application facilitates establishment of a secure connection between the mobile device 100a and the one or more financial institution servers 200. The one or more processors 110a are operable to execute the mobile application to facilitate user access to the one or more financial accounts and user management of the one or more financial accounts.

The memory 120a also includes one or more data stores 123a that are operable to store one or more types of data. The mobile device 100a may include one or more interfaces that facilitate one or more systems or modules thereof to transform, manage, retrieve, modify, add, or delete, the data residing in the data stores 123a. The one or more data stores 123a may comprise volatile and/or non-volatile memory. Examples of suitable data stores 123a include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 123a may be a component of the one or more processors 110a or alternatively, may be operatively connected to the one or more processors 110a for use thereby. As set forth, described, and/or illustrated herein, “operatively connected” may include direct or indirect connections, including connections without direct physical contact.

The memory 120a also includes an SMS module 124a operable to facilitate user transmission and receipt of text messages via the mobile device 100a though the network 300. In one example embodiment, the user may receive text messages from the financial institution that are associated with the user access and the user management of the one or more financial accounts. An email module 125a is operable to facilitate user transmission and receipt of email messages via the mobile device 100a through the network 300. In one example embodiment, the user may receive email messages from the financial institution that are associated with the user access and the user management of the one or more financial accounts. The user may utilize a web browser module 126a that is operable to facilitate user access to one or more websites associated with the financial institution through the network 300. A digital wallet module 127a facilitates the generation of one or more digital wallets associated with the one or more financial accounts.

In accordance with one or more embodiments set forth, described, and/or illustrated herein, the mobile device 100a includes an I/O hub 130a operatively connected to other systems and subsystems of the mobile device 100a. The I/O system 130a may include one or more of an input interface, an output interface, and a network controller to facilitate communications between the mobile device 100a and the one or more financial institution servers 200. The input interface and the output interface may be integrated as a single, unitary user interface 131a, or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 110a to execute instructions. The input interface may comprise a user interface (UI), a graphical user interface (GUI), such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the mobile device 100a may serve as both a component of the input interface and a component of the output interface.

The mobile device 100a also includes a network interface 140a operable to facilitate connection to the network 300. The mobile device 100a further includes a power source 150a that comprises a wired powered source, a wireless power source, a replaceable battery source, or a rechargeable battery source.

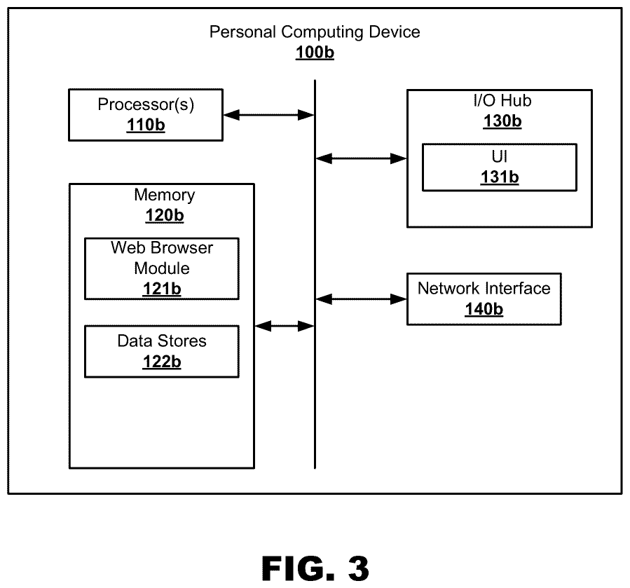

In the illustrated example embodiment of FIG. 3, the client device 100 comprises a personal computing device 100b. Some of the possible operational elements of the personal computing device 100b are illustrated in FIG. 3 and will now be described herein. It will be understood that it is not necessary for the personal computing device 100b to have all the elements illustrated in FIG. 3. For example, the personal computing device 100b may have any combination of the various elements illustrated in FIG. 3. Moreover, the personal computing device 100b may have additional elements to those illustrated in FIG. 3.

The personal computing device 100b includes one or more processors 110b, a non-transitory memory 120b operatively coupled to the one or more processors 110A, an I/O hub 130b, and a network interface 140b.

The memory 120b comprises a set of instructions of computer-executable program code. The set of instructions are executable by the one or more processors 110b to cause control of the web browser module 121b in a manner that facilitates user access to a web browser having one or more websites associated with the financial institution through the network 300.

The memory 120b also includes one or more data stores 122b that are operable to store one or more types of data. The personal computing device 100b may include one or more interfaces that facilitate one or more systems or modules thereof to transform, manage, retrieve, modify, add, or delete, the data residing in the data stores 122b. The one or more data stores 122b may comprise volatile and/or non-volatile memory. Examples of suitable data stores 122b include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 122b may be a component of the one or more processors 110b, or alternatively, may be operatively connected to the one or more processors 110b for use thereby. As set forth, described, and/or illustrated herein, “operatively connected” may include direct or indirect connections, including connections without direct physical contact.

In accordance with one or more embodiments set forth, described, and/or illustrated herein, “processor” means any component or group of components that are operable to execute any of the processes described herein or any form of instructions to carry out such processes or cause such processes to be performed. The one or more processors 100b may be implemented with one or more general-purpose and/or one or more special-purpose processors. Examples of suitable processors include graphics processors, microprocessors, microcontrollers, DSP processors, and other circuitry that may execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The one or more processors 110b may comprise at least one hardware circuit (e.g., an integrated circuit) operable to carry out instructions contained in program code. In embodiments in which there is a plurality of processors, such processors may work independently from each other, or one or more processors may work in combination with each other.

In accordance with one or more embodiments set forth, described, and/or illustrated herein, the personal computing device 100a includes an I/O hub 130b operatively connected to other systems and subsystems of the personal computing device 100a. The I/O system 130b may include one or more of an input interface, an output interface, and a network controller to facilitate communications between the personal computing device 100a and the one or more financial institution servers 200. The input interface and the output interface may be integrated as a single, unitary user interface 131b, or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 110b to execute instructions. The input interface may comprise a user interface (UI), a graphical user interface (GUI), such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the mobile device 100a may serve as both a component of the input interface and a component of the output interface.

The personal computing device 100b also includes a network interface 140b operable to facilitate connection to the network 300.

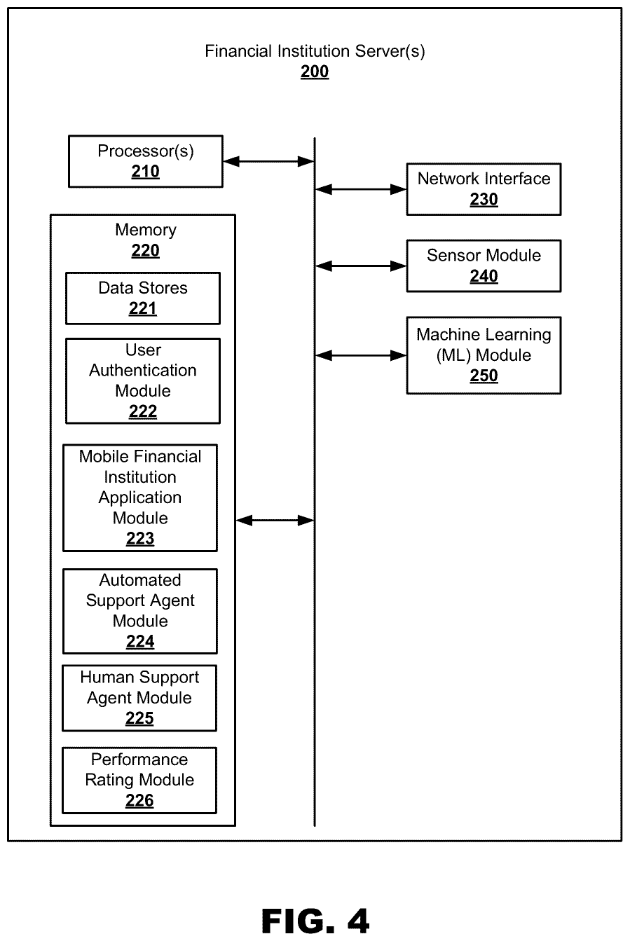

As illustrated in FIG. 4, the one or more financial institution servers 200 includes one or more processors 210, a non-transitory memory 220 operatively coupled to the one or more processors 210, a network interface 230, a sensor module 240, and a machine learning (ML) module 250. Some of the possible operational elements of each server in the one or more financial institution servers 200 are illustrated in FIG. 4 and will now be described herein. It will be understood that it is not necessary for each server in the one or more financial institution servers 200 to have all the elements illustrated in FIG. 4. For example, each server in the one or more financial institution servers 200 may have any combination of the various elements illustrated in FIG. 4. Moreover, each server in the one or more financial institution servers 200 may have additional elements to those illustrated in FIG. 4.

The one or more financial institution servers 200 may be controlled by a system manager (or policy manager) of the financial institution.

In accordance with one or more embodiments set forth, described, and/or illustrated herein, the one or more financial institution servers 200 may comprise a computing device, including but not limited to a server computer, a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the one or more financial institution servers 200 comprising any form of electronic device that optimizes or otherwise transforms the performance and functionality of the one or more embodiments in a manner that falls within the spirit and scope of the principles of this disclosure.

The memory 220 comprises a set of instructions of computer-executable program code. The set of instructions are executable by the one or more processors 210 in manner that facilitates control of a user authentication module 222, a mobile financial institution application module 223 having one or more mobile financial institution applications that reside in the memory 220, an automated virtual support agent module 224, a human support agent module 225, and a performance rating module 226. In accordance with one or more embodiments set forth, described, and/or illustrated herein, the one or more financial institution servers 200 may individually or collectively execute the instructions to perform any one or more of the methodologies set forth, described, and illustrated herein. The automated virtual support agent module 224 may execute natural language processing (NLP) based on natural language input by the user via the client device 100.

The memory 220 also includes one or more data stores 221 that are operable to store one or more types of data, including but not limited to, user account data, user authentication data, sensor data, etc. For instance, the one or more data stores 221 may comprise a storage location on which one or more electronic files of the transcripts associated with virtual chat communications reside. The one or more data stores 221 may comprise volatile and/or non-volatile memory. Examples of suitable data stores 221 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 221 may be a component of the one or more processors 210, or alternatively, may be operatively connected to the one or more processors 210 for use thereby. As set forth, described, and/or illustrated herein, “operatively connected” may include direct or indirect connections, including connections without direct physical contact.

The memory 220 may include a single machine-readable medium, or a plurality of media (e.g., a centralized or distributed database, or associated caches and servers) operable to store the instructions. The term “machine-readable medium” shall also be taken to include any medium, or combination of multiple media, that is capable of storing instructions (e.g., software) for execution by a server (e.g., server), such that the instructions, when executed by the one or more processors 210, cause the one or more financial institution servers 200 to perform any one or more of the methodologies set forth, described, and illustrated herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

The computer-executable program code may instruct the one or more processors 210 to cause the user authentication module 221 to authenticate a user in order to gain user access to the one or more financial accounts. The user authentication module 221 may be caused to request user input user data or user identification that include, but are not limited to, user identity (e.g., username), a user passcode, a cookie, user biometric data, a private key, a token, and/or another suitable authentication data or information.

The computer-executable program code may instruct the one or more processors 210 to execute certain logic, data-processing, and data-storing functions of the one or more financial institution servers 200, in addition to certain communication functions of the one or more financial institution servers 200. The one or more mobile financial institution applications of the mobile financial institution application module 222 are operable to communicate with the mobile device 100a and the personal computing device 100b in a manner which facilitates user access to the one or more financial accounts in addition to user management of the one or more financial accounts based on successful user authentication.

The sensor module 240 is operable, at least during execution of the mobile application by the client device 100, to dynamically detect, determine, assess, monitor, measure, quantify, and/or sense information about the client device 100. The sensor module 240 may be operable to detect, determine, assess, monitor, measure, quantify and/or sense in real-time. The sensor module 240 may be operable to detect, determine, assess, monitor, measure, quantify, and/or sense geographic location information about the geographic location of the client device 100.

The ML module 250 may include one or more ML algorithms to train one or more machine learning models of the one or more financial institution servers 200 based on data and/or information resided in the memory 220. The ML algorithms may include one or more of a linear regression algorithm, a logical regression algorithm, or a combination of different algorithms. A neural network may also be used to train the system based on the received data. The ML module 250 may analyze the received data and/or information, and transform the data and/or information in a manner which provides enhanced communication between the client device 100 and the one or more financial institution servers 200, while also enhancing user access and management of the one or more financial accounts. The data and/or information may also be up-linked to other systems and modules in the one or more financial institution servers 200 for further processing to discover additional information that may be used to enhance the understanding of the information.

In accordance with one or more embodiments set forth, described, and/or illustrated herein, the network 300 may comprise a wireless network, a wired network, or any suitable combination thereof. For example, the network 300 is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

In accordance with one or more embodiments set forth, described, and/or illustrated herein, a user may, via the client device 100, execute a mobile financial institution application over the communication network 300.

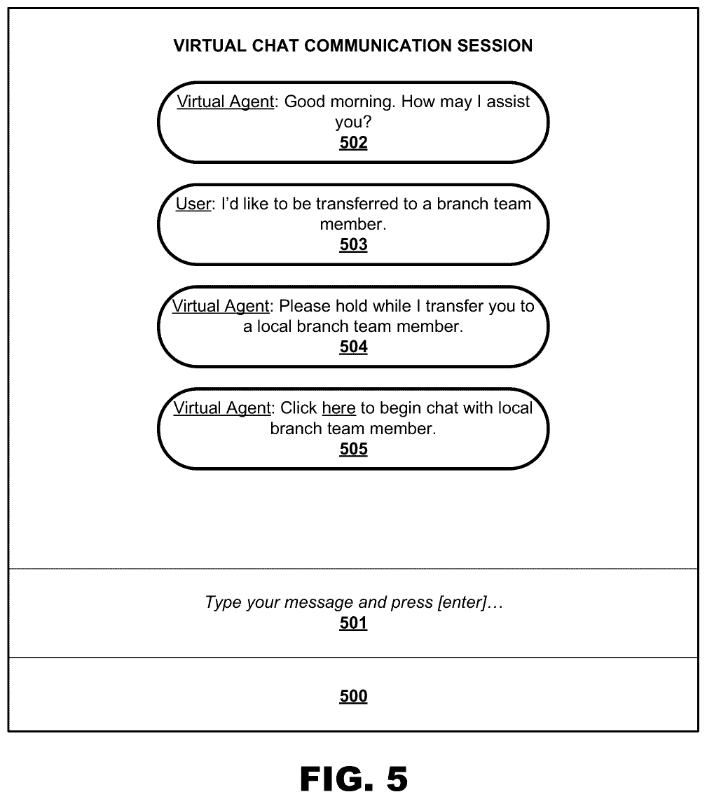

As illustrated in FIG. 5, upon a user launching a financial institution mobile application or desktop application on the client device 100, and being authenticated by the user authentication module 221, the computer-executable program code may instruct the one or more processors 210 to cause or generate a visual display of a graphical user interface (GUI) on the user interface 131a, 131b of the client device 100. The GUI comprises a chat interface or widget 500 that facilitates a virtual chat communication session in natural language communicated verbally and/or textually with an intelligent automated assistant that includes, but is not limited to an automated virtual support agent or chatbot. The communication session comprises natural language input and natural language output in the form of chat messages 502 through 505 between the user and the automated virtual support agent or chatbot. The chat messages 502 through 505 may be in verbal or textual form. A chat box 501 is provided to enter chat messages intended for the virtual support agent (e.g., queries, commands, etc.) which are then visually displayed as a chat message. The virtual chat communication session may include one or more probing questions (e.g., natural language output) by the automated virtual support agent or chatbot and natural language input in the form of chat messages. For instance, during the virtual chat communication session, the user may send a chat message 503 comprising a general request or command to be transferred to a human virtual support agent of the financial institution. In response thereto, the computer-executable program code may instruct the one or more processors 210 to execute processing or analysis (e.g., via parsing and/or Natural Language Processing (NLP)) of the natural language input command (chat message 503). In response to executing the processing or analysis of the natural language input request or command (chat message 503), the computer-executable program code may instruct the one or more processors 210 to cause the automated virtual support agent or chatbot may respond with a chat message 504 asking or prompting the user to hold in order to route, transfer, or make a handover of the virtual chat communication session to a human virtual support agent, for example a local human virtual support agent.

In particular, in response to receipt of the request, the computer-executable program code may instruct the one or more processors 210 to execute processing or analysis of the natural language input (chat message 503). Responsive to executing the processing or analysis, the computer-executable program code may instruct the one or more processors 210 to cause or generate a visual display of a graphical user interface (GUI) on the user interface 131a, 131b of the client device 100. The GUI may include an electronic notification (e.g., text, email, pop-up notification, etc.) of a request or query for user authorization of a detection of the current geographic location of the client device 100. Responsive to the one or more financial institution servers 200 receiving user authorization from the client device 100, the computer-executable program code may instruct the one or more processors 210 to cause the one or more financial institution servers 200 to detect the current geographic location of the client device 100. Alternatively, this disclosure contemplates the request or query to authorize the detection of the current geographic location of the client device 100 occurring temporally before user authentication is conducted. Alternatively, this disclosure contemplates the computer-executable program code instructing the one or more processors 210 to automatically detect the current geographic location of the client device 100 without prior user authorization.

The computer-executable program code may instruct the one or more processors 210 to cause the sensor module 240 to detect the current geographic location of the client device 100. The detection may be based on wireless network connectivity data, stored geographic location data residing in the memory 220, and sensor data relating to the detected current geographic location of the client device 100. The wireless network connectivity data may include but is not limited to, an internet protocol (IP) address of the client device 100, network identifier for the network 300, Wi-Fi and Bluetooth Media Access Control (MAC) address, radio-frequency identification (RFID), Wi-Fi connection location, or device GPS and Global System for Mobile Communications (GSM)/code division multiple access (CDMA) cell IDs, etc. The sensor data may include but is not limited to, global positioning system (GPS) data of the client device 100. This disclosure contemplates conducting the geographic location analysis based on any data indicative of a geographic location of the client device 100 and which optimizes or otherwise transforms the performance and functionality of the one or more embodiments in a manner that falls within the spirit and scope of the principles of this disclosure.

The routing, transfer, or handover of the virtual chat communication session to a local human virtual support agent is implemented to local human virtual support agent who is available at the current moment and whom also has not previously engaged in a predetermine number of chats during the business day. In this regard, the computer-executable program code may instruct the one or more processors 210 to cause (e.g., via the mobile financial institution application module 223, the automated virtual support agent module 224, and/or the human support agent module 225), human virtual support agent analysis based on data and information that are detected in real-time or stored in the memory 220. The data and information may include, but is not limited to, an appointment calendar or scheduling information of each local human virtual support agent, the experience level of each local human virtual support agent, and the specialized knowledge/training of each local human virtual support agent. This disclosure contemplates executing the geographic location analysis and the human virtual support agent analysis contemporaneously (i.e., in parallel or simultaneously) to each other.

Based on the detected current geographic location and/or the human virtual support agent analysis, the computer-executable program code may instruct the one or more processors 210 to cause (e.g., via the mobile financial institution application module 223, the automated virtual support agent module 224, and/or the human virtual support agent module 225), the transmission of an electronic notification via message 505 that includes a user-engageable link that, when engaged by the user, facilitates the routing, transfer, or handover of the virtual chat communication session to a local human virtual support agent of the financial institution that is at a branch office located within a predetermined threshold distance from the detected current geographic location of the client device 100. The local human virtual support agent may have conducted a previous virtual chat communication session with the user, the transcript of which is stored in memory 220.

The branch office can be located a predetermined threshold distance from the detected current geographic location. The predetermined threshold distance can be set by the user via the client device 100 and as input setting that is stored in memory 220. For example, the computer-executable program code may instruct the one or more processors 210 to cause or generate a visual display of a GUI on the UI 131a, 131b of the client device 100, the GUI including one or more tiles having a toggle-switch or check boxes that enable the user to select between a plurality of threshold distances (e.g., 5 miles, 10 miles, 25 miles, etc.).

Alternatively, the computer-executable program code may instruct the one or more processors 210 to cause (e.g., via the mobile financial institution application module 223, the automated virtual support agent module 224, and/or the human support agent module 225), based on the detected current geographic location and/or the human virtual support agent analysis, the direct routing of the virtual chat communication session to a human virtual support agent of the financial institution that is at a branch office located within a predetermined threshold distance from the detected current geographic location of the client device 100.

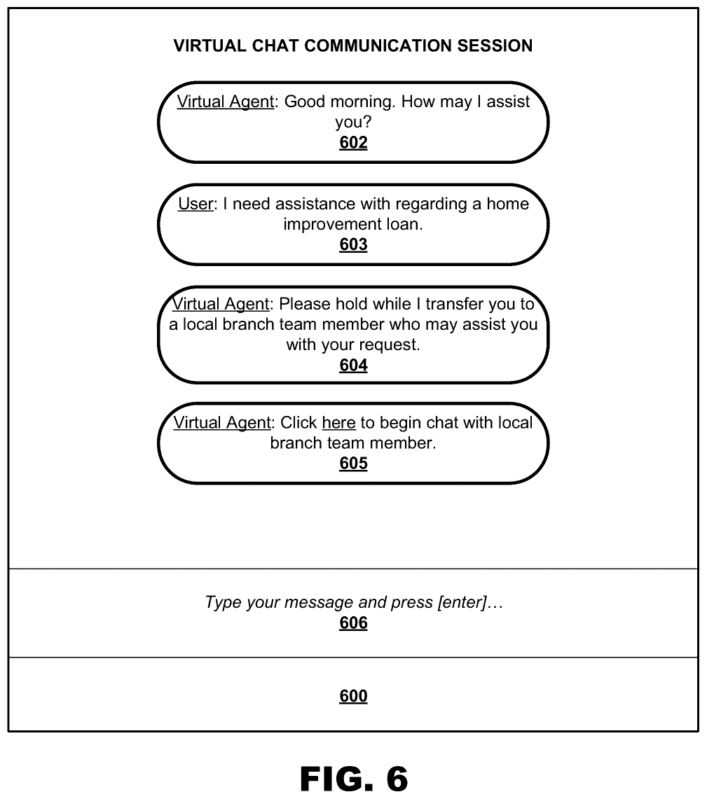

As illustrated in FIG. 6, upon a user launching a financial institution mobile application or desktop application on the client device 100, and being authenticated by the user authentication module 221, the computer-executable program code may instruct the one or more processors 210 to cause or generate a visual display of a graphical user interface (GUI) on the user interface 131a, 131b of the client device 100. The GUI comprises a chat interface or widget 600 that facilitates a virtual chat communication session in natural language communicated verbally and/or textually with an intelligent automated assistant that includes, but is not limited to an automated virtual support agent or chatbot. A chat box 601 is provided to enter chat messages intended for the virtual support agent (e.g., queries, commands, etc.) which are then visually displayed as a chat message. The communication session comprises natural language input and natural language output in the form of chat messages 602 through 605 between the user and the automated virtual support agent. The chat messages 602 through 605 may be in verbal or textual form. The virtual chat communication session may include one or more probing questions (e.g., natural language output) by the automated virtual support agent and natural language input in the form of chat messages. For instance, during the virtual chat communication session, the user may transmit a chat message 603 comprising a service request, command, or query for a specific financial service (e.g., home loan, commercial loan, etc.) that is offered by the financial institution. Such financial services may include, but are not limited to, a personal financial services, commercial financial services, and wealth management financial services. In response thereto, the computer-executable program code may instruct the one or more processors 210 to execute processing or analysis (e.g., via parsing and/or Natural Language Processing (NLP)) of the natural language input command (chat message 603). In response to executing the processing or analysis of the natural language input request or command (chat message 603), the computer-executable program code may instruct the one or more processors 210 to cause the automated virtual support agent or chatbot may respond with a chat message 604 asking or prompting the user to hold in order to route, transfer, or make a handover of the virtual chat communication session to a human virtual support agent (e.g., a local human virtual support agent) having specialized knowledge and/or experience in the financial service being requested by the user.

In particular, in response to receipt of the request, the computer-executable program code may instruct the one or more processors 210 to execute the processing or analysis of the natural language input (message 603). Responsive to executing the processing or analysis, the computer-executable program code may instruct the one or more processors 210 to cause or generate a visual display of a graphical user interface (GUI) on the user interface 131a, 131b of the client device 100. The GUI may comprise an electronic notification (e.g., text, email, pop-up notification, etc.) of a request or query for user authorization of a detection of the current geographic location of the client device 100. Responsive to the one or more financial institution servers 200 receiving user authorization from the client device 100, the computer-executable program code may instruct the one or more processors 210 to cause the one or more financial institution servers 200 to detect the current geographic location of the client device 100. Alternatively, this disclosure contemplates the request or query to authorize the detection of the current geographic location of the client device 100 occurring temporally before user authentication is conducted. Alternatively, this disclosure contemplates the computer-executable program code instructing the one or more processors 210 to automatically detect the current geographic location of the client device 100 without prior user authorization.

The computer-executable program code may instruct the one or more processors 210 to cause the sensor module 240 to detect the current geographic location of the client device 100. The detection may be based on wireless network connectivity data, stored geographic location data residing in the memory 220, and sensor data relating to the detected current geographic location of the client device 100. The wireless network connectivity data may include but is not limited to, an internet protocol (IP) address of the client device 100, network identifier for the network 300, Wi-Fi and Bluetooth Media Access Control (MAC) address, radio-frequency identification (RFID), Wi-Fi connection location, or device GPS and Global System for Mobile Communications (GSM)/code division multiple access (CDMA) cell IDs, etc. The sensor data may include but is not limited to, global positioning system (GPS) data of the client device 100. This disclosure contemplates conducting the geographic location analysis based on any data indicative of a geographic location of the client device 100 and which optimizes or otherwise transforms the performance and functionality of the one or more embodiments in a manner that falls within the spirit and scope of the principles of this disclosure.

The routing, transfer, or handover of the virtual chat communication session to a local human virtual support agent is implemented to local human virtual support agent who is available at the current moment and whom also has not previously engaged in a predetermine number of chats during the business day. In this regard, the computer-executable program code may instruct the one or more processors 210 to cause (e.g., via the mobile financial institution application module 223, the automated virtual support agent module 224, and/or the human support agent module 225), human virtual support agent analysis based on data and information that are detected in real-time or stored in the memory 220. The data and information may include, but is not limited to, an appointment calendar or scheduling information of each local human virtual support agent, the experience level of each local human virtual support agent, and the specialized knowledge/training of each local human virtual support agent. This disclosure contemplates executing the geographic location analysis and the human virtual support agent analysis contemporaneously (i.e., in parallel or simultaneously) to each other.

Based on the detected current geographic location and/or the human virtual support agent analysis, the computer-executable program code may instruct the one or more processors 210 to cause (e.g., via the mobile financial institution application module 223, the automated virtual support agent module 224, and/or the human virtual support agent module 225), the transmission of an electronic notification via chat message 605 that includes a user-engageable link that, when engaged by the user, facilitates the routing, transfer, or handover of the virtual chat communication session to a local human virtual support agent of the financial institution that is at a branch office located within a predetermined threshold distance from the detected current geographic location of the client device 100. The local human virtual support agent may have specialized knowledge and/or experience in the financial service being requested by the user. The local human virtual support agent may have conducted a previous virtual chat communication session with the user, the transcript of which is stored in memory 220.

The branch office can be located a predetermined threshold distance from the detected current geographic location. The predetermined threshold distance can be set by the user via the client device 100 and as input setting that is stored in memory 220. For example, the computer-executable program code may instruct the one or more processors 210 to cause or generate a visual display of a GUI on the UI 131a, 131b of the client device 100, the GUI including one or more tiles having a toggle-switch or check boxes that enable the user to select between a plurality of threshold distances (e.g., 5 miles, 10 miles, 25 miles, etc.).

Alternatively, the computer-executable program code may instruct the one or more processors 210 to cause (e.g., via the mobile financial institution application module 223, the automated virtual support agent module 224, and/or the human support agent module 225), based on the detected current geographic location and/or the human virtual support agent analysis, the direct routing of the virtual chat communication session to a human virtual support agent of the financial institution that is at a branch office located within a predetermined threshold distance from the detected current geographic location of the client device 100.

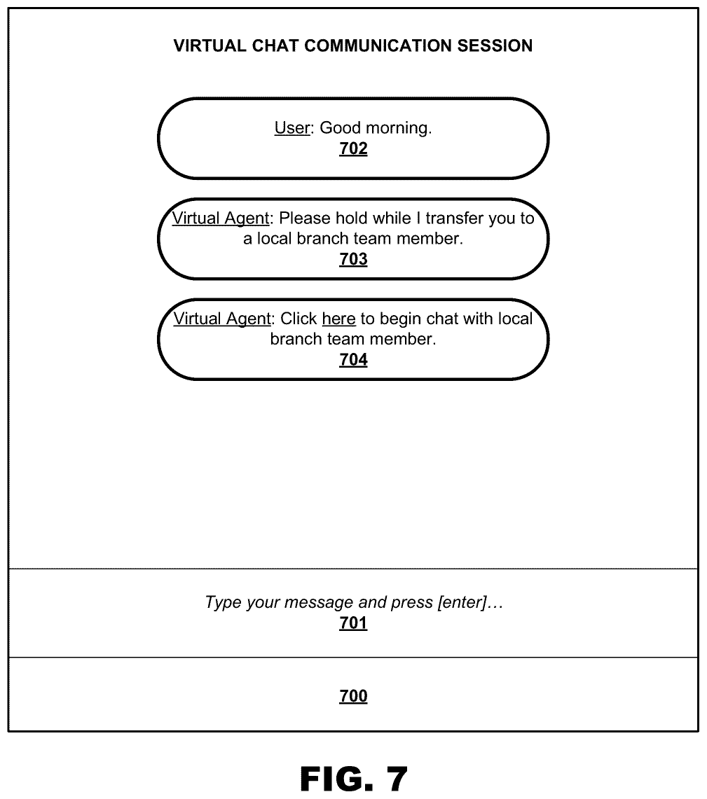

As illustrated in FIG. 7, upon a user launching a financial institution mobile application or desktop application on the client device 100, and being authenticated by the user authentication module 221, the computer-executable program code may instruct the one or more processors 210 to cause or generate a visual display of a graphical user interface (GUI) on the user interface 131a, 131b of the client device 100. The GUI comprises a chat interface or widget 700 that facilitates a virtual chat communication session in natural language communicated verbally and/or textually with an intelligent automated assistant that includes, but is not limited to an automated virtual support agent. A chat box 701 is provided to enter chat messages intended for the virtual support agent (e.g., queries, commands, etc.) which are then visually displayed as a chat message. The communication session comprises natural language input and natural language output in the form of chat messages 702 through 704 between the user and the automated virtual support agent. The chat messages 702 through 704 may be in verbal or textual form. The virtual chat communication session may include one or more probing questions (e.g., natural language output) by the automated virtual support agent and natural language input in the form of chat messages. For instance, the user may initiate the virtual chat communication session by sending a general chat message 702. In response thereto, the computer-executable program code may instruct the one or more processors 210 to execute processing or analysis (e.g., via parsing and/or Natural Language Processing (NLP)) of the natural language input command (chat message 702). In response to executing the processing or analysis of the natural language input request or command (chat message 702), the computer-executable program code may instruct the one or more processors 210 to cause the automated virtual support agent or chatbot to respond with a chat message 703 asking or prompting the user to hold in order to route, transfer, or make a handover of the virtual chat communication session to a human virtual support agent (e.g., a local human virtual support agent).

In particular, in response to receipt of the request, the computer-executable program code may instruct the one or more processors 210 to execute the processing or analysis of the natural language input (chat message 702). Responsive to executing the processing or analysis, the computer-executable program code may instruct the one or more processors 210 to cause or generate a visual display of a graphical user interface (GUI) on the user interface 131a, 131b of the client device 100. The GUI may include an electronic notification (e.g., text, email, pop-up notification, etc.) of a request, prompt, or query for user authorization of a detection of the current geographic location of the client device 100. Responsive to the one or more financial institution servers 200 receiving user authorization from the client device 100, the computer-executable program code may instruct the one or more processors 210 to cause the one or more financial institution servers 200 to detect the current geographic location of the client device 100. Alternatively, this disclosure contemplates the request or query to authorize the detection of the current geographic location of the client device 100 occurring temporally before user authentication is conducted. Alternatively, this disclosure contemplates the computer-executable program code instructing the one or more processors 210 to automatically detect the current geographic location of the client device 100 without prior user authorization.

The computer-executable program code may instruct the one or more processors 210 to cause the sensor module 240 to detect the current geographic location of the client device 100. The detection may be based on wireless network connectivity data, stored geographic location data residing in the memory 220, and sensor data relating to the detected current geographic location of the client device 100. The wireless network connectivity data may include but is not limited to, an internet protocol (IP) address of the client device 100, network identifier for the network 300, Wi-Fi and Bluetooth Media Access Control (MAC) address, radio-frequency identification (RFID), Wi-Fi connection location, or device GPS and Global System for Mobile Communications (GSM)/code division multiple access (CDMA) cell IDs, etc. The sensor data may include but is not limited to, global positioning system (GPS) data of the client device 100. This disclosure contemplates conducting the geographic location analysis based on any data indicative of a geographic location of the client device 100 and which optimizes or otherwise transforms the performance and functionality of the one or more embodiments in a manner that falls within the spirit and scope of the principles of this disclosure.

The routing, transfer, or handover of the virtual chat communication session will be initiated to a local human virtual support agent who is available at the current moment and whom also has not previously engaged in a predetermine number of chats during the business day. In this regard, the computer-executable program code may instruct the one or more processors 210 to cause (e.g., via the mobile financial institution application module 223, the automated virtual support agent module 224, and/or the human support agent module 225), human virtual support agent analysis based on data and information that are detected in real-time or stored in the memory 220. The data and information may include, but is not limited to, an appointment calendar or scheduling information of each local human virtual support agent, the experience level of each local human virtual support agent, and the specialized knowledge/training of each local human virtual support agent. This disclosure contemplates executing the geographic location analysis and the human virtual support agent analysis contemporaneously (i.e., in parallel or simultaneously) to each other.

Based on the detected current geographic location and/or the human virtual support agent analysis, the computer-executable program code may instruct the one or more processors 210 to cause (e.g., via the mobile financial institution application module 223, the automated virtual support agent module 224, and/or the human support agent module 225), the transmission of an electronic notification via chat message 704 that comprises a user-engageable link that, when engaged by the user, facilitates the routing, transfer, or handover of the virtual chat communication session to a local human virtual support agent of the financial institution that is at a branch office located within a predetermined threshold distance from the detected current geographic location of the client device 100. The local human virtual support agent may have specialized knowledge and/or experience in the financial service being requested by the user. The local human virtual support agent may have conducted a previous virtual chat communication session with the user, the transcript of which is stored in memory 220.

The branch office can be located a predetermined threshold distance from the detected current geographic location. The predetermined threshold distance can be set by the user via the client device 100 and as input setting that is stored in memory 220. For example, the computer-executable program code may instruct the one or more processors 210 to cause or generate a visual display of a GUI on the UI 131a, 131b of the client device 100, the GUI including one or more tiles having a toggle-switch or check boxes that enable the user to select between a plurality of threshold distances (e.g., 5 miles, 10 miles, 25 miles, etc.).

Alternatively, the computer-executable program code may instruct the one or more processors 210 to cause (e.g., via the mobile financial institution application module 223, the automated virtual support agent module 224, and/or the human support agent module 225), based on the detected current geographic location and/or the human virtual support agent analysis, the direct routing of the virtual chat communication session to a human virtual support agent of the financial institution that is at a branch office located within a predetermined threshold distance from the detected current geographic location of the client device 100.

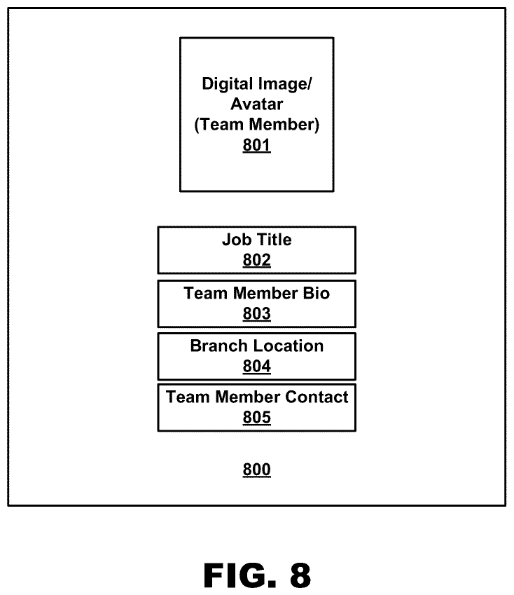

As illustrated in FIG. 8, alternatively or additionally, in accordance with one or more embodiments set forth, described, and/or illustrated herein, the computer-executable program code may instruct the one or more processors 210 to cause the display of a GUI comprising a widget 800 on the user interface 131a, 131b of the client device 100. For example, the widget 800 includes a professional profile of the local human virtual support agent to whom the virtual chat communication session is being routed or transferred. The profile may include a plurality of tiles that visually display information related to the local human virtual support agent. Such tiles may include, but is not limited to, a tile 801 comprising a digital image (e.g., an avatar or a photographic image) of the local human virtual support agent, a tile 802 comprising a job title of the local human virtual support agent, a tile 803 comprising a biography of the local human virtual support agent, a tile 804 comprising a specific geographic location of the branch of the financial institution associated with the local human virtual support agent, and a tile 805 comprising contact information (e.g., email address, telephone number, etc.) of the local human virtual support agent.

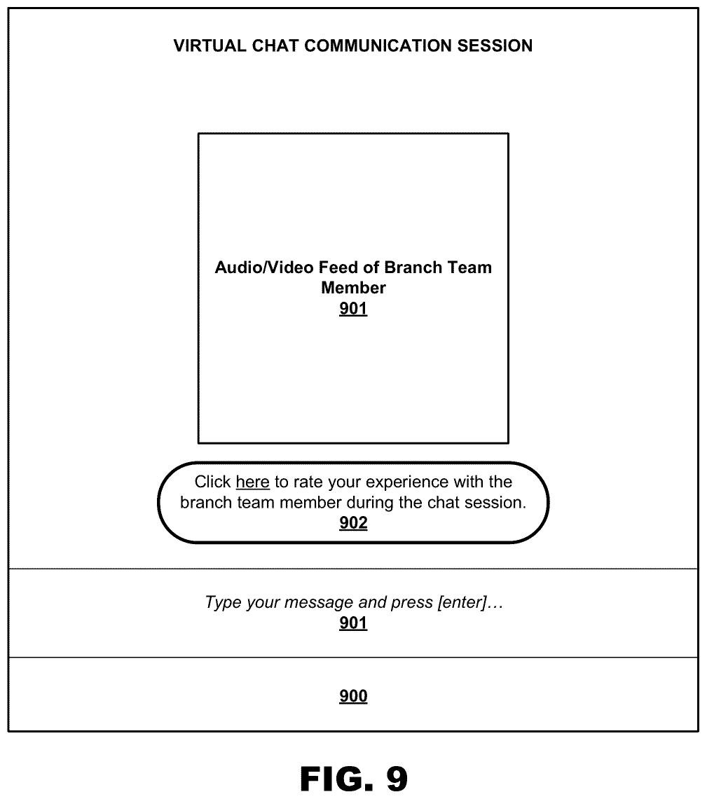

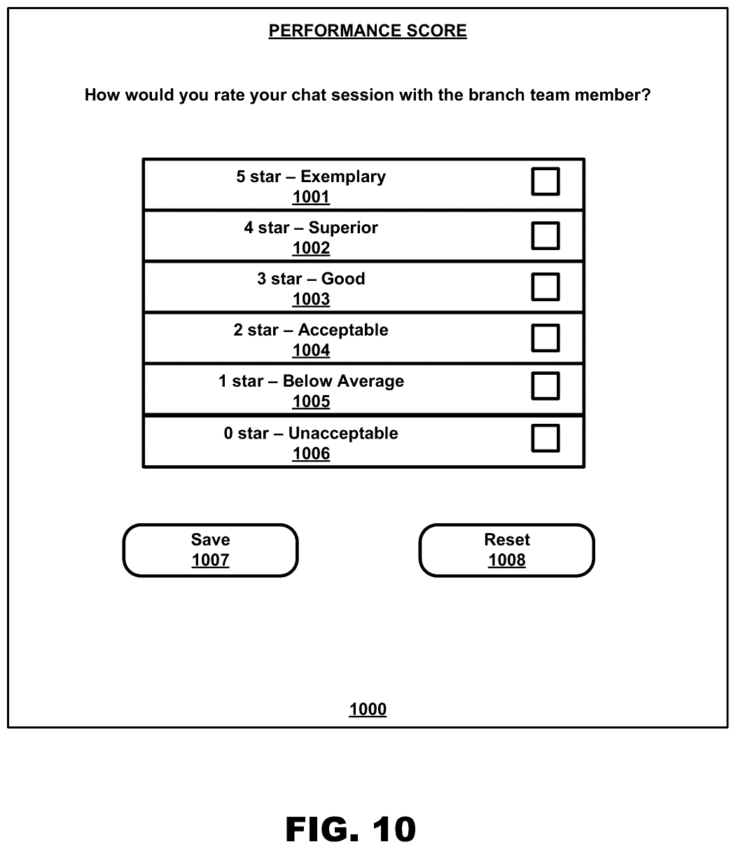

As illustrated in FIG. 9, alternatively or additionally, in accordance with one or more embodiments set forth, described, and/or illustrated herein, the computer-executable program code may instruct the one or more processors 210 to cause display of a graphical user interface (GUI) comprising a chat interface or widget 900 for visual display on a user interface 131a, 131b of the client device 100 during execution of a mobile financial institution application over the communication network 300. The GUI 900 comprises an audio/video feed 901 that facilitates a first virtual chat communication session (e.g., a textual virtual chat communication session or a video virtual chat communication session) between the user and a human virtual support agent of the financial institution.

During or temporally after the virtual chat communication session, the computer-executable program code may instruct the one or more processors 210 to transmit a GUI 1000 for visual display on the user interface 131a, 131b of the client device 100. The GUI 902 comprising a user-engageable link that, when engaged by the user, prompts the user to rate the experience with the human virtual support agent in the virtual chat communication session.

As illustrated in FIG. 10, in response to the user engaging the user-engageable link, the computer-executable program code may instruct the one or more processors 210 to cause display of a GUI 1000 for visual display on a user interface 131a, 131b of the client device 100. The GUI 1000 comprises a dashboard or a widget having a plurality of tiles 1001-1006 including one or more tiles having a toggle-switch or check boxes that enable the user to select a performance score among a plurality of numerical values that are indicative of the overall performance attributes of the human virtual support agent as it relates to the virtual chat communication session. The numerical value may be in a range of between 0 to 5, with 0 being indicative of a low or unacceptable performance and 5 being indicative of an outstanding or exemplary performance. This disclosure contemplates assigning any suitable range of numerical values that optimizes or otherwise transforms the performance and functionality of the one or more embodiments in a manner that falls within the spirit and scope of the principles of this disclosure.

The GUI 1000 also includes a user-engageable icon 1007 to save the performance score, and a user-engageable icon 1008 to reset the performance score to a default setting.

In response to the user submitting or otherwise saving the performance score, the computer-executable program code may instruct the one or more processors 210 to store the performance score in the non-transitory memory 220 as human virtual support agent data. The computer-executable program code may then instruct the one or more processors 210 to execute a calculation of a composite performance rating for the human virtual support agent based on the storing or otherwise acquiring the performance score for the human virtual support agent. The composite performance rating is indicative of the overall performance attributes of the human virtual support agent, and comprises an average of performance scores that are accumulated for the human virtual support agent and stored in the non-transitory memory 220. The composite performance rating may be based on an accumulation of performance scores assigned to the human virtual support agent by customers of the financial institution who have engaged in a virtual chat communication session with a human virtual support agent, or an accumulation of performance scores assigned to the human virtual support agent by the user. In response to the calculating, the computer-executable program code may instruct the one or more processors 210 to store the composite performance rating in the non-transitory memory 220 as human virtual support agent data.

The computer-executable program code may instruct the one or more processors 210 to cause, temporally after calculating the composite performance rating, display of one of the GUIs 500, 600, 700 to facilitate a second virtual chat communication session (e.g., a textual virtual chat communication session or a video virtual chat communication session) between the user and an automated virtual support agent of the financial institution. During the virtual chat communication session with the automated virtual support agent, the user may send: a message 501b comprising a general request to be transferred to a human virtual support agent of the financial institution, or a message 601b comprising a service request or query for a specific financial service (e.g., home loan, commercial loan, etc.) that is offered by the financial institution, or a general message 701a.

During the second virtual chat communication session between the user and the automated virtual support agent and in response to the message 501b, 601b, or 701a, the computer-executable program code may instruct the one or more processors 210 to execute one or more of human virtual support agent analysis and the geographic location analysis. The human virtual support agent analysis may be conducted based on the human virtual support agent data that is stored in the non-transitory memory 220. The human virtual support agent data may include composite performance rating, calendar data, scheduling data, educational data, and professional experience data of human virtual support agents, including the human virtual support agent who previously conducted a virtual chat communication session with the user.

The computer-executable program code may instruct the one or more processors 210 to cause, in response to executing one or more of human virtual support agent analysis and the geographic location analysis, routing of the second virtual chat communication session to a human virtual support agent of the financial institution. In particular, the computer-executable program code may instruct the one or more processors 210 to route the second virtual chat communication session to the human virtual support agent of the financial institution based on a composite performance rating that is indicative of an exemplary performance attributes of the human virtual support agent. The computer-executable program code may instruct the one or more processors 210 to restrict routing of the second virtual chat communication session to a human virtual support agent based on a composite performance rating that is indicative of a poor performance rating of the human virtual support agent.

In particular, the computer-executable program code may instruct the one or more processors 210 to cause (e.g., via the mobile financial institution application module 223, the automated virtual support agent module 224, the human support agent module 225, and/or the performance rating module 226), the transmission of an electronic notification via message 501d, 601d, 701c that includes a user-engageable link that, when engaged by the user, facilitates the routing, transfer, or handover of the virtual chat communication session from the automated virtual support agent to the human virtual support agent of the financial institution based on the composite performance rating of the human virtual support agent.

Alternatively, the computer-executable program code may automatically route the virtual chat communication session to the human virtual support agent by instructing the one or more processors 210 to cause to display of the GUI 900 for visual display on the user interface 131a, 131b of the client device 100.

In accordance with one or more embodiments set forth, described, and/or illustrated herein, a second virtual chat communication session between a user and an automated virtual support agent may be routed to a human virtual support agent based on the geographic location analysis and the human virtual support agent analysis executed by the one or more financial institution servers 200. The geographic location analysis and the human virtual support agent analysis consider one or more data points stored in the non-transitory memory 220, including but not limited to: the composite performance rating of each human virtual support agent, an appointment calendar or scheduling information of each human virtual support agent, the experience level of each human virtual support agent, the specialized knowledge/training of each human virtual support agent, and the geographic location of the client device 100.

The routing, transfer, or handover of the second virtual chat communication session from an automated virtual support agent to a human virtual support agent may be initiated when the human virtual support agent is currently available and whom also has not previously engaged in a predetermine number of virtual chat communication sessions during the business day. In this regard, the computer-executable program code may instruct the one or more processors 210 to cause (e.g., via the mobile financial institution application module 223, the automated virtual support agent module 224, and/or the human support agent module 225), human virtual support agent analysis based on data and information that are detected in real-time or stored in the memory 220. The data and information may include, but is not limited to, the composite performance rating of each human virtual support agent, an appointment calendar or scheduling information of each local human virtual support agent, the experience level of each local human virtual support agent, and the specialized knowledge/training of each local human virtual support agent. This disclosure contemplates executing the geographic location analysis and the human virtual support agent analysis contemporaneously (i.e., in parallel) to each other.

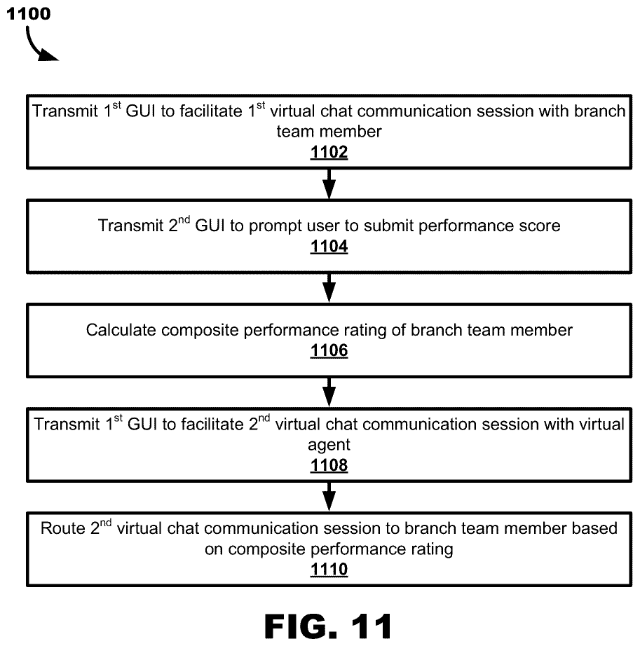

Illustrated examples shown in FIGS. 11 to 13 set forth computer-implemented methods 1100, 1200, and 1300. In one or more examples, the respective flowcharts of the computer-implemented methods 1100, 1200, and 1300 may be implemented by the one or more processors 210 of the one or more financial institution servers 200. In particular, the computer-implemented methods 1100, 1200, and 1300 may be implemented as one or more modules in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

In accordance with one or more embodiments set forth, described, and/or illustrated herein, software executed by the one or more financial institution servers 200 provides functionality described or illustrated herein. In particular, software executed by the one or more processors 210 is operable to perform one or more processing blocks of the computer-implemented methods 1100, 1200, and 1300 set forth, described, and/or illustrated herein, or provides functionality set forth, described, and/or illustrated.

As illustrated in FIG. 11, illustrated process block 1102 includes transmitting, by one or more financial institution servers associated with a financial institution, a first GUI or chat interface for visual display on a user interface of a client device of a user executing a mobile financial institution application or a desktop financial institution application associated with the financial institution over a communication network, the first GUI operable to facilitate a first virtual chat communication session between a human virtual support agent and the user.

In accordance with illustrated process block 1102, the first GUI comprises an audio/video feed that facilitates the first virtual chat communication session.

The computer-implemented method 1100 may then proceed to illustrated process block 1104, which includes transmitting, by the one or more financial institution servers to the client device during the virtual chat communication session, a second GUI for visual display on the user interface.

In accordance with illustrated process block 1104, the second GUI comprises a user-engageable link that, when engaged by the user, prompts the user to submit a performance score of the human virtual support agent that is a numerical value indicative of overall performance attributes of the human virtual support agent.

The computer-implemented method 1100 may then proceed to illustrated process block 1106, which includes executing, by the one or more financial institution servers temporally after acquiring the performance score, a calculation of a composite performance rating for the human virtual support agent.

In accordance with illustrated process block 1106, the composite performance rating is an average of performance scores that are accumulated for the human virtual support agent.

In accordance with illustrated process block 1106, the composite performance rating is based on performance scores given by all customers of the financial institution.

In accordance with illustrated process block 1106, the composite performance rating is based on performance scores given by the user.

The computer-implemented method 1100 may then proceed to illustrated process block 1108, which includes transmitting, by the one or more financial institution servers temporally after calculating the composite performance rating, the first GUI for visual display on the user interface of the client device to facilitate a second virtual chat communication session between an automated virtual support agent and the user.

The computer-implemented method 1100 may then proceed to illustrated process block 1110, which includes routing, by the one or more financial institution servers, the second virtual chat communication session from the automated virtual support agent to a human virtual support agent of the financial institution based on a composite performance rating for the human virtual support agent.

In accordance with illustrated process block 1110, the second virtual chat communication session is routed to the human virtual support agent based on a composite performance rating that is indicative of an exemplary performance attributes of the human virtual support agent.

In accordance with illustrated process block 1110, the second virtual chat communication session is not routed to a human virtual support agent based on a composite performance rating that is indicative of a poor performance rating of the human virtual support agent.

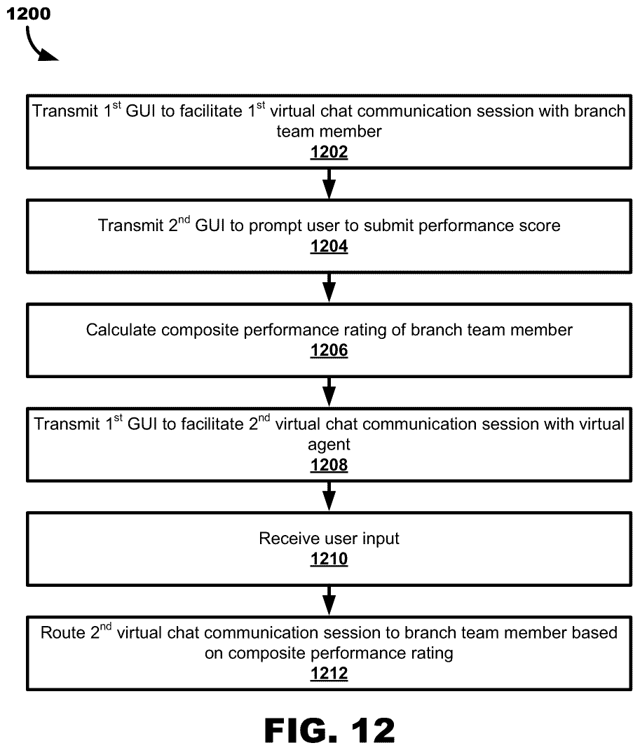

As illustrated in FIG. 12, illustrated process block 1202 includes transmitting, by one or more financial institution servers associated with a financial institution, a first GUI for visual display on a user interface of a client device of a user executing a mobile financial institution application or a desktop financial institution application associated with the financial institution over a communication network, the first GUI operable to facilitate a first virtual chat communication session between a human virtual support agent and the user.

In accordance with illustrated process block 1202, the first GUI comprises an audio/video feed that facilitates the first virtual chat communication session.

The computer-implemented method 1200 may then proceed to illustrated process block 1204, which includes transmitting, by the one or more financial institution servers to the client device during the virtual chat communication session, a second GUI for visual display on the user interface.

In accordance with illustrated process block 1204, the second GUI comprises a user-engageable link that, when engaged by the user, prompts the user to submit a performance score of the human virtual support agent that is a numerical value indicative of overall performance attributes of the human virtual support agent.

The computer-implemented method 1200 may then proceed to illustrated process block 1206, which includes executing, by the one or more financial institution servers temporally after acquiring the performance score, a calculation of a composite performance rating for the human virtual support agent.

In accordance with illustrated process block 1206, the composite performance rating is an average of performance scores that are accumulated for the human virtual support agent.

In accordance with illustrated process block 1206, the composite performance rating is based on performance scores given by all customers of the financial institution.

In accordance with illustrated process block 1206, the composite performance rating is based on performance scores given by the user.

The computer-implemented method 1200 may then proceed to illustrated process block 1208, which includes transmitting, by the one or more financial institution servers temporally after calculating the composite performance rating, the first GUI for visual display on the user interface of the client device to facilitate a second virtual chat communication session between an automated virtual support agent and the user.

The computer-implemented method 1200 may then proceed to illustrated process block 1210, which includes receiving, by the one or more financial institution servers during the second virtual chat communication session, a user input message.

In accordance with illustrated process block 1210, the user input message comprises a vocal/audio message to the virtual agent.

In accordance with illustrated process block 1210, the user input message comprises a text message to the virtual agent.

In accordance with illustrated process block 1210, the user input message comprises a request to transfer the second virtual chat communication session to a human virtual support agent of the financial institution.

In accordance with illustrated process block 1210, the user input message comprises a request for a specific financial service (e.g., home loan, commercial loan, etc.) that is offered by the financial institution.

The computer-implemented method 1200 may then proceed to illustrated process block 1212, which includes routing, by the one or more financial institution servers in response to the user input, the second virtual chat communication session from the automated virtual support agent to a human virtual support agent of the financial institution based on a composite performance rating for the human virtual support agent.

In accordance with illustrated process block 1212, the second virtual chat communication session is routed to the human virtual support agent based on a composite performance rating that is indicative of an exemplary performance attributes of the human virtual support agent.

In accordance with illustrated process block 1212, the second virtual chat communication session is not routed to a human virtual support agent based on a composite performance rating that is indicative of a poor performance rating of the human virtual support agent.

The computer-implemented method 1200 may terminate or end after execution of process block 1212.

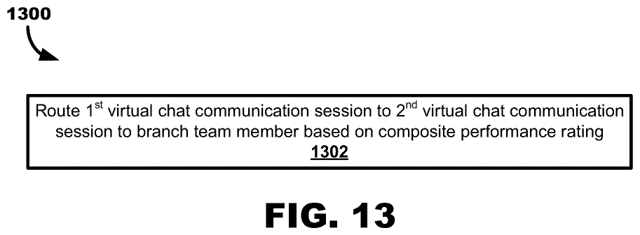

As illustrated in FIG. 13, illustrated process block 1302 includes routing, by one or more financial institution servers associated with a financial institution during virtual chat communication session between an automated virtual support agent and a user on a client device executing a mobile financial institution application or a desktop financial institution application associated with the financial institution over a communication network, the virtual chat communication session from the automated virtual support agent to a human virtual support agent of the financial institution based on a composite performance rating for the human virtual support agent.

In accordance with illustrated process block 1302, the composite performance rating is an average of performance scores that are accumulated for the human virtual support agent.

In accordance with illustrated process block 1302, the composite performance rating is based on performance scores given by all customers of the financial institution.

In accordance with illustrated process block 1302, the composite performance rating is based on performance scores given by the user.

In accordance with illustrated process block 1302, the virtual chat communication session is routed to the human virtual support agent based on a composite performance rating that is indicative of an exemplary performance attributes of the human virtual support agent.

In accordance with illustrated process block 1302, the second virtual chat communication session is not routed to a human virtual support agent based on a composite performance rating that is indicative of a poor performance rating of the human virtual support agent.

The computer-implemented method 1300 may terminate or end after execution of process block 1302.

In accordance with one or more embodiments set forth, described, and/or illustrated herein, the mobile device 100a, the personal computing device 100b, and the one or more financial institution servers 200 could function in a fully virtualized environment. A virtual machine is where all hardware is virtual and operation is run over a virtual processor. The benefits of computer virtualization have been recognized as greatly increasing the computational efficiency and flexibility of a computing hardware platform. For example, computer virtualization facilitates multiple virtual computing machines to execute on a common computing hardware platform. Similar to a physical computing hardware platform, virtual computing machines include storage media, such as virtual hard disks, virtual processors, and other system components associated with a computing environment. For example, a virtual hard disk can store the operating system, data, and application files for a virtual machine. Virtualized computer system includes computing device or physical hardware platform, virtualization software running on hardware platform, and one or more virtual machines running on hardware platform by way of virtualization software. Virtualization software is therefore logically interposed between the physical hardware of hardware platform and guest system software running “in” virtual machine.

Memory of the hardware platform may store virtualization software and guest system software running in virtual machine. Virtualization software performs system resource management and virtual machine emulation. Virtual machine emulation may be performed by a virtual machine monitor (VMM) component. In typical implementations, each virtual machine (only one shown) has a corresponding VMM instance. Depending on implementation, virtualization software may be unhosted or hosted. Unhosted virtualization software generally relies on a specialized virtualization kernel for managing system resources, whereas hosted virtualization software relies on a commodity operating system: the “host operating system,” such as Windows or Linux to manage system resources. In a hosted virtualization system, the host operating system may be considered as part of virtualization software.

The system and method described herein may be at least partially processor-implemented, the one or more processors 210 being an example of hardware. For example, at least some of the operations of the computer-implemented methods may be performed by the one or more processors 210 or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors 210, not only residing within a single machine, but deployed across a plurality of machines. In some example embodiments, the one or more processors 210 or processor-implemented modules may be located in a single geographic location (e.g., within a home environment, an office environment, or a server farm). In other example embodiments, the one or more processors or processor-implemented modules may be distributed across a plurality of geographic locations.

Devices that are described as in “communication” with each other or “coupled” to each other need not be in continuous communication with each other or in direct physical contact, unless expressly specified otherwise. On the contrary, such devices need only transmit to each other as necessary or desirable, and may actually refrain from exchanging data most of the time. For example, a machine in communication with or coupled with another machine via the Internet may not transmit data to the other machine for long period of time (e.g. weeks at a time). In addition, devices that are in communication with or coupled with each other may communicate directly or indirectly through one or more intermediaries.

The terms “coupled,” “attached,” or “connected” may be used herein to refer to any type of relationship, direct or indirect, between the components in question, and may apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the exemplary embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. An apparatus, comprising:
one or more processors; and
a non-transitory memory coupled to the one or more processors, the non-transitory memory including a set of instructions of computer-executable program code, which when executed by the one or more processors, cause the apparatus to:
cause, during execution of a mobile application or desktop application associated with a financial institution by a client device of a user over a communication network, a visual display of a chat interface on the client device to facilitate a virtual chat communication session between the user and a virtual support agent of the financial institution; and
route the virtual chat communication session from the automated virtual support agent to a human virtual support agent based on a composite performance rating for the human virtual support agent.

2. The apparatus of claim 1, wherein, the set of instructions, which when executed by the one or more processors, cause the apparatus to, temporally before causing the visual display of the chat interface on the client device to facilitate the virtual chat communication session:
acquire, from the user, a performance score of the human virtual support agent that is a numerical value indicative of overall performance attributes of the human virtual support agent;
execute, temporally after acquiring the performance score, a calculation of the composite performance rating for the human virtual support agent; and
store the composite performance rating in a storage location.

3. The apparatus of claim 2, wherein the composite performance rating is an average of performance scores that are accumulated for the human virtual support agent and stored in the non-transitory memory.

4. The apparatus of claim 3, wherein the composite performance rating is based on performance scores given by all customers of the financial institution.

5. The apparatus of claim 3, wherein the composite performance rating is based on performance scores given by the user.

6. The apparatus of claim 2, wherein the set of instructions, which when executed by the one or more processors, cause the apparatus to route the virtual chat communication session to the human virtual support agent based on a composite performance rating that is indicative of an exemplary performance attributes of the human virtual support agent.

7. The apparatus of claim 2, wherein the set of instructions, which when executed by the one or more processors, cause the apparatus to restrict routing of the virtual chat communication session to the human virtual support agent based on a composite performance rating that is indicative of a poor performance rating of the human virtual support agent.

8. A computer program product comprising at least one non-transitory computer readable medium having with a set of instructions of computer-executable program code, which when executed by one or more processors of a computing device, cause the computing device to:
cause, during execution of a mobile application or desktop application associated with a financial institution by a client device of a user over a communication network, a visual display of a chat interface on the client device to facilitate a virtual chat communication session between the user and a virtual support agent of the financial institution; and
route the virtual chat communication session from the automated virtual support agent to a human virtual support agent based on a composite performance rating for the human virtual support agent.

9. The computer program product of claim 8, wherein the set of instructions, which when executed by the one or more processors, cause the computing device to, temporally before causing the visual display of the chat interface on the client device to facilitate the virtual chat communication session:
acquire, from the user, a performance score of the human virtual support agent that is a numerical value indicative of overall performance attributes of the human virtual support agent;
execute, temporally after acquiring the performance score, a calculation of the composite performance rating for the human virtual support agent; and
store the composite performance rating in a storage location.

10. The computer program product of claim 9, wherein the composite performance rating is an average of performance scores that are accumulated for the human virtual support agent.

11. The computer program product of claim 10, wherein the composite performance rating is based on performance scores given by all customers of the financial institution.

12. The computer program product of claim 10, wherein the composite performance rating is based on performance scores given by the user.

13. The computer program product of claim 9, wherein the set of instructions, which when executed by the one or more processors, cause the computing device to route the virtual chat communication session to the human virtual support agent based on a composite performance rating that is indicative of an exemplary performance attributes of the human virtual support agent.

14. The computer program product of claim 9, wherein the set of instructions, which when executed by the one or more processors, cause the computing device to restrict routing of the virtual chat communication session to the human virtual support agent based on a composite performance rating that is indicative of a poor performance rating of the human virtual support agent.

15. A computer-implemented method, comprising:
causing, by one or more financial institution servers associated with a financial institution during execution of a mobile application or desktop application associated with the financial institution by a client device of a user over a communication network, a visual display of a chat interface on the client device to facilitate a virtual chat communication session between the user and an automated virtual support agent of the financial institution; and
routing, by the one or more financial institution servers, the virtual chat communication session from the automated virtual support agent to a human virtual support agent based on a composite performance rating for the human virtual support agent.

16. The computer-implemented method of claim 15, further comprising, temporally before causing the visual display of the chat interface on the client device to facilitate the virtual chat communication session:
acquiring, by the one or more financial institution servers from the client device, a performance score of the human virtual support agent that is a numerical value indicative of overall performance attributes of the human virtual support agent;
executing, by the one or more financial institution servers temporally after acquiring the performance score, a calculation of the composite performance rating for the human virtual support agent; and
storing, by the one or more financial institution servers, the composite performance rating in a storage location.

17. The computer-implemented method of claim 16, wherein the composite performance rating is an average of performance scores that are accumulated for the human virtual support agent.

18. The computer-implemented method of claim 17, wherein the composite performance rating is based on performance scores given by all customers of the financial institution.

19. The computer-implemented method of claim 17, wherein the composite performance rating is based on performance scores given by the user.

20. The computer-implemented method of claim 16, wherein:
the virtual chat communication session is routed to the human virtual support agent based on a composite performance rating that is indicative of an exemplary performance attributes of the human virtual support agent, and
routing of the virtual chat communication session to the human virtual support agent is restricted based on a composite performance rating that is indicative of a poor performance rating of the human virtual support agent.
